(19) United States
(12) Patent Application Publication
(10) Pub. No.: US 2014/0124494 A1
(43) Pub. Date: May 8, 2014

(54) CAR INTERIOR COMPARTMENT HEATER

(71) Applicants: Chih-Chang WEI, New Taipei City (TW); Etsuro HABATA, New Taipei City (TW)

(72) Inventors: Chih-Chang WEI, New Taipei City (TW); Etsuro HABATA, New Taipei City (TW)

(73) Assignee: BETACERA INC.

(21) Appl. No.: 13/668,320

(22) Filed: Nov. 5, 2012

(51) Int. Cl. H05B 1/00

(52) U.S. Cl. 219/202

(57) ABSTRACT

A heater used in car interior compartment includes a framework and a heating module. The framework includes a first base and a second base arranged in interval with the first base. The heating module is provided between the first base and the second base. The heating module includes a PTC heating component, a thermal conduction glue, a pair of electrode plate, a insulation thermal conduction glue, and a pair of thermal diffusion body. The electrode plate is stuck to both sides of the PTC heating component by the thermal conduction glue. Each thermal diffusion body connects each electrode plate in an insulation way by the insulation thermal conduction glue, and the heat generating and the anti electricity leakage effect of the heater can be improved.

### BACKGROUND

1. Technical Field

The present invention relates to a heater, especially a heater used in car interior compartment.

2. Related Art

The cooling water of the car engine can not absorb enough heat from the engine at the very beginning right after the car is activated, and thus the temperature of the cooling water is not high enough to be used as heating of the interior compartment of the car. In order to improve the comfort when driving in cold weather, an interior compartment heater is installed in the car to provide the warm air right after the car is activated, thereby enhancing comfort for the driver.

The conventional heater used in the interior compartment of the car mainly includes a first base, a second base, and a heating module connected between the first base and the second base. The heating module includes a positive temperature coefficient (PTC) heating component, a pair of electrode plates stuck both sides of the PTC heating component, and a pair of thermal diffusion body sticking to each of the electrode plates respectively. The control circuit of the heater is provided inside the first base.

The conventional car interior compartment heater has the following drawbacks. First, the well-arranged PTC heating components, each electrode plates, and each thermal diffusion body are clipped by the clamp of machines to be assembled into the first base and the second base, which means the assembling of the heater should depend on the clamp of the machines, and thus causes inconvenience of the assembling. Furthermore, if the control circuit is short circuited or damaged, the first base should be taken off from the heater to fix the control circuit. As a result, the PTC heating components, each electrode plates, and each thermal diffusion body are disassembled because of lacking the clipping by the first base, and the heater is not easy to be reassembled back to the original condition after the control circuit is fixed. Second, the contact surfaces between each electrode plate and the PTC heating components are not smooth and not compactly sticking to the electrode plate and the PTC heating components, so the efficiency of the power conduction from each electrode plate to the PTC heating components is not good enough, thereby further resulting in bad heat generating efficiency of the PTC heating components. And also, the efficiency of conducting the heat generated by the PTC heating components to each electrode plate is not good enough as well. Third, only insulation thermal tape is used between each electrode plate and each thermal diffusion body to insulate the electricity. However, since the insulation effect of the insulation thermal tape is not good and also easy to be scratched, the electricity leakage happens frequently due to the conduction of the electricity from the electrode plates to each thermal diffusion body. Fourth, the surfaces of each electrode plate and the insulation thermal tape are not smooth, and the insulation thermal tape is not compactly stuck to each electrode plate. Moreover, the heat conduction effect of the insulation thermal tape is not good as well, and thus decreases the effect of heat conduction from each electrode plate to each thermal diffusion body, thereby lowering the heat generating efficiency of the heater.

### BRIEF SUMMARY

The present invention provides a heater used in car interior compartment. The present invention connects each electrode plate to the PTC heating components by a thermal conduction glue, thereby improving the efficiency of conducting the electricity from each electrode plate to the PTC heating components, and the heating effect of the PTC heating components can be improved accordingly.

The present invention also provides a heater used in car interior compartment, and each electrode plate and each thermal diffusion body are connected with an insulation thermal conduction glue to prevent the electricity leakage by avoiding the electricity conducting from each electrode plate to each thermal diffusion body.

A heater used in car interior compartment includes a framework and a heating module. The framework includes a first base and a second base arranged in interval with the first base. The heating module is provided between the first base and the second base. The heating module includes a PTC heating component, a thermal conduction glue, a pair of electrode plate, a insulation thermal conduction glue, and a pair of thermal diffusion body. The electrode plate is stuck to both sides of the PTC heating component by the thermal conduction glue. Each thermal diffusion body connects each electrode plate in an insulation way by the insulation thermal conduction glue.

The present invention has the advantages as follows. First, the heat conduction from the PTC heating plates to each electrode plate can be improved by the thermal conduction glue which has the thermal conduction feature. Second, the control circuit can be repaired from the opening trough of the first base without taking off the first base from the heater, thereby saving the time of repairing and maintaining Third, when the car is driven in a bumping road, the vibration of the heating module can be mitigated by the spring plate of the fixation stand and each side plate, and the collision of the heating module and the framework can be prevented. Fourth, a side of the sheet metal can be formed with a plurality of long strip shape dents to increase the air contact area for each fin to improve the heat exchanging effect, thereby improving the heating effect of the heater as well. Besides, the thickness of the fins, as well as the material cost can also be reduced.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is an assembled stereogram of the first preferred embodiment according to the present invention;

FIG. 2 is perspective view of the first preferred embodiment according to the present invention;

FIG. 3 is an exploded perspective view of the first preferred embodiment according to the present invention;

FIG. 4 is an exploded perspective view of the heating module of the first preferred embodiment according to the present invention;

FIG. 5 is a schematic view of the partially magnified first embodiment according to the present invention;

FIG. 6 is a three dimensional schematic view of the first preferred embodiment according to the present invention;

FIG. 7 is a schematic view of the fins of the second embodiment according to the present invention;

FIG. 8 is an operation diagram of the second embodiment according to the present invention; and

FIG. 9 is a schematic view of the fins of the third embodiment according to the present invention.

### DETAILED DESCRIPTION

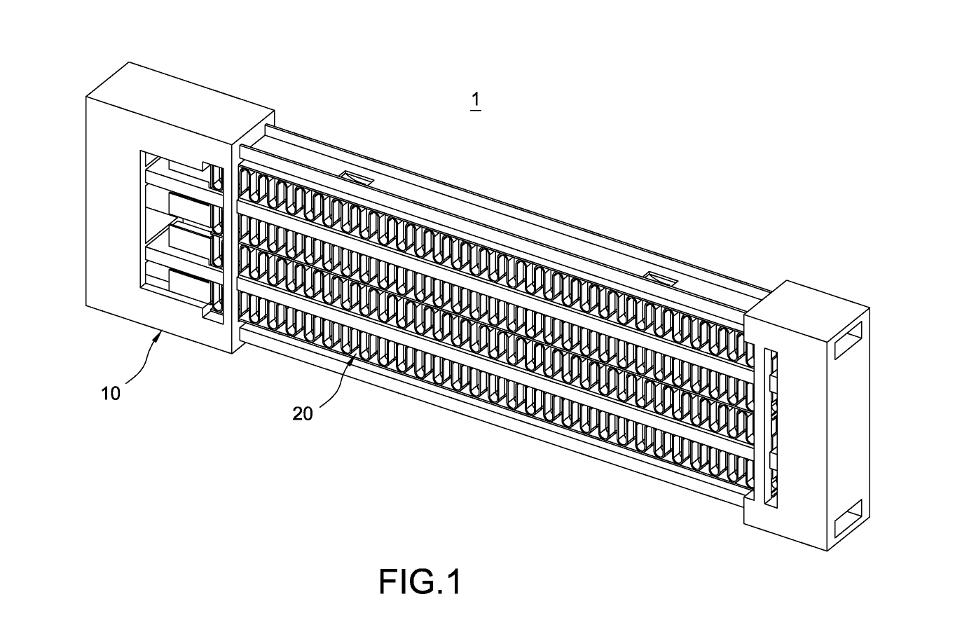

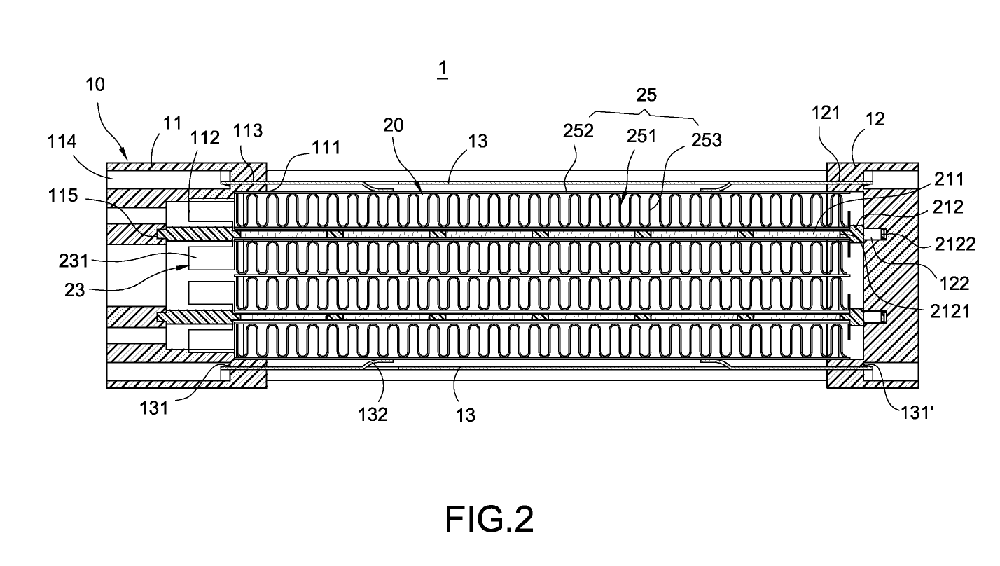

Please refer to FIGS. 1 and 2, which are the assembled stereogram and the perspective view of the first preferred embodiment according to the present invention. The present invention provides a car interior compartment heater 1, which includes a framework 10 and a heating module 20.

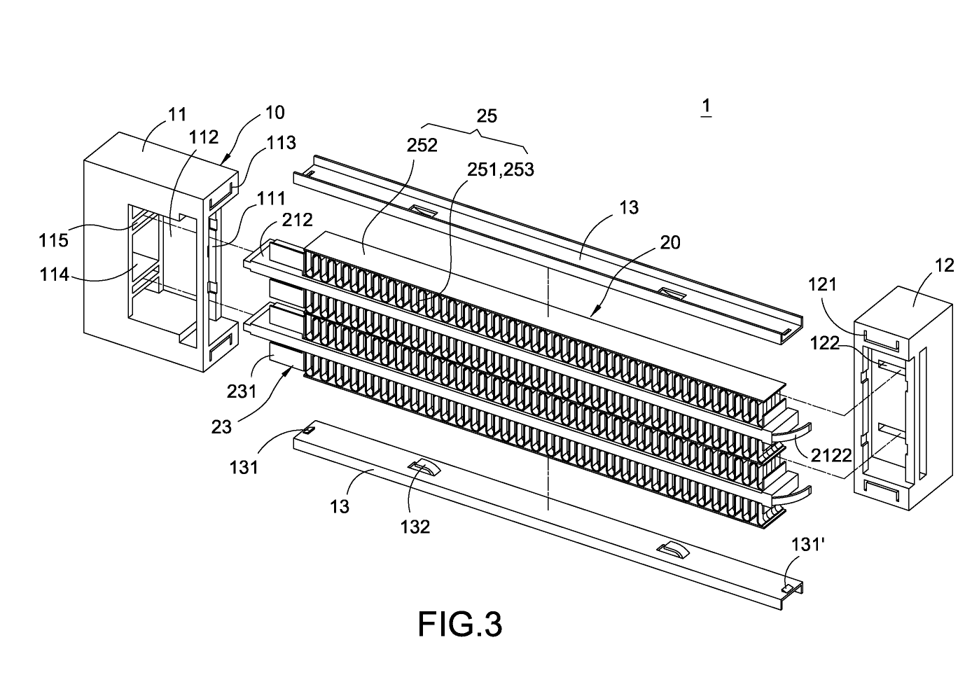

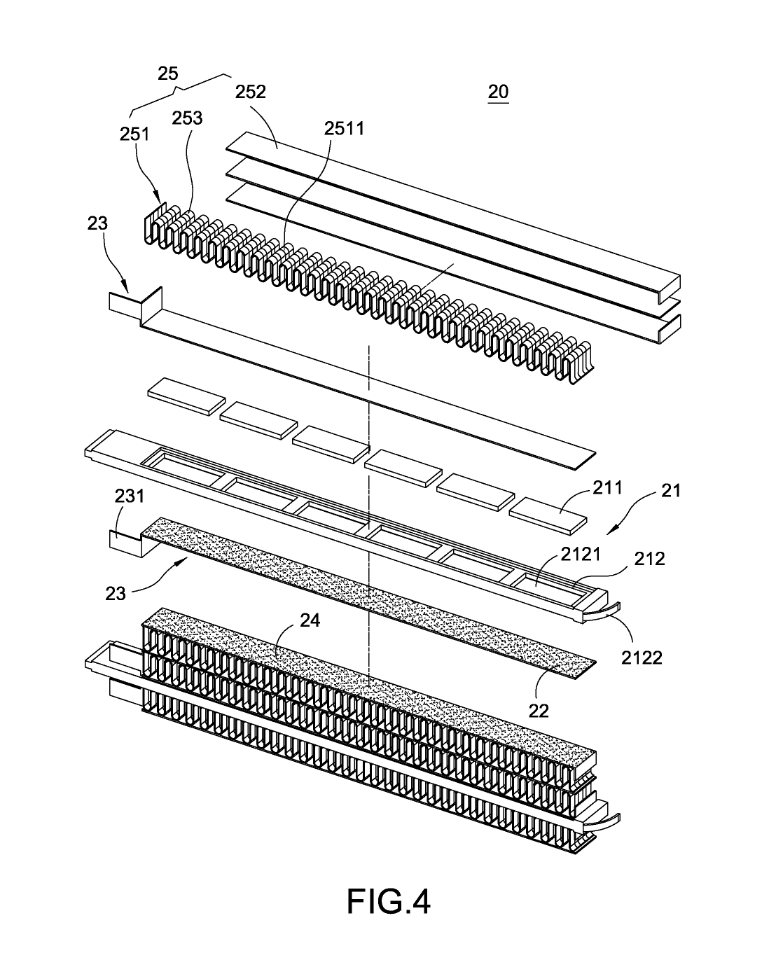

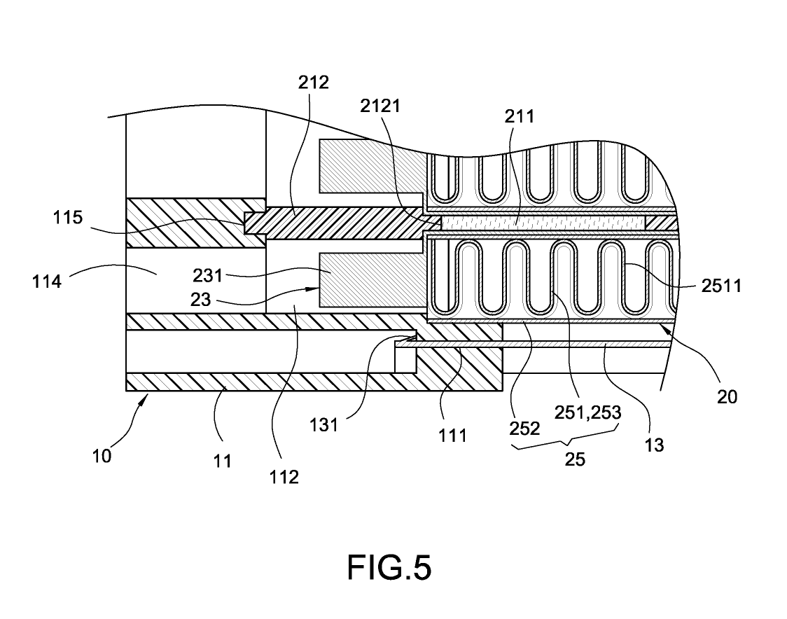

Please refer to FIGS. 3 to 5, which are the exploded perspective view, the exploded perspective view of the heating module, and the schematic view of the partially magnified first embodiment according to the present invention. The framework 10 includes a first base 11, a second base 12, and a pair of side plates 13. The first base and the second base are arranged in interval, and the heating module 20 is connected between the first base 11 and the second base 12. The first base 11 is provided with a slot 111, an open trough 112, a pair of first clipping slots 113, a plurality of through holes 114, and a first inserting hole 115. The slot 111 and each first clipping slot 113 are provided on one end near the heating module 20 of the first base 11, and each first clipping slot 113 is provided on both sides of the slot 111. The open trough 112 is provided on one side of the first base 11 and communicates with the slot 111. Each through hole 114 and the first inserting hole 115 are provided on one end which is away from the heating module 20 and communicate with the slot 111, respectively. The first base 11 is a component preferably made of plastic.

The second base 12 is provided with a pair of second clipping slots 121 and a second inserting hole 122. Each second clipping slot 121 is provided on both sides of the second inserting hole 122. The second base is a component made of plastic.

The side plate 13 is provided on both sides of the heating module 20. Both ends of each side plate 13 are connected to the first base 11 and the second base 12 in a way of welding or lodging, respectively. Each side plate 13 is a component made of metal.

If the side plate 13 is connected with the first base 11 and the second base 12 by lodging, tenons 131, 131′are provided on both ends of each side plate 13. The tenons 131 of each side plate 13 are lodged with each first clipping slot 113 of the first base 11 respectively, and the other tenons 131 of each side plate 13 are lodged with each second clipping slot 121 of the second base 12 respectively. Besides, the side of each side plate 13 that is near the heating module 20 is provided with a plurality of spring plates 132.

The heating module 20 includes a PTC heating module 21, a thermal conduction glue 22, a pair of electrode plates 23, an insulation thermal conduction glue 24, and a pair of thermal diffusion bodys 25. The PTC heating component 21 includes a plurality of PTC heating plates 211 and a fixation stand 212. The fixation stand 212 is provided with a plurality of fixation troughs 2121, and each PTC heating plate 211 is fixed inside each fixation trough 2121. One end of the fixation stand 212 is inserted and fixed in the first inserting hole 115 of the first base 11, and the other end of the fixation stand 212 is inserted and fixed in the second inserting hole 122 of the second base 12. Besides, the end of the fixation stand 212 that is near the second base 12 is provided with a spring plate 2122, and the sprint plate 2122 is against the bottom surface of the second inserting hole 122 of the second base 12. Each PTC heating plate 211 is a component made of ceramic material which has positive temperature coefficient. The insulation thermal conduction glue 24 is a component made of base material mixed with ceramic powder, and the ceramic powder can be alumina, silicon nitride, aluminum nitride, or silicon carbide. The thermal conduction glue 22 can be a component made of silicone, epoxy resin, or plastic, and the thermal conduction glue 22 can also be added with electric conductive material, such as copper or silver, etc., to enhance the electric conduction of the thermal conduction glue 22, but not limited thereto.

The electrode plate 23 connects to both sides of the fixation stand 212. The electrode plate 23 stuck to both sides of the PTC heating plate 211 by the thermal conduction glue 22. The side of each electrode plate 23 that is near the first base 11 is provided with a conductive terminal 231, and each conductive terminal 231 is inserted into the slot 111 and exposed to the open trough 112 of the first base 11. The electrode plate 23 is a component made of copper or copper alloy.

Each thermal diffusion body 25 is provided with a plurality of fins 251 and a pair of fixation plates 252. Each fin 251 is formed with a wave form sheet metal 253, and each fixation plate 252 connects to both sides of each fin 251 in the way of welding. The side of the fixation plate 252 of each thermal diffusion body 25 that is near each electrode plate 23 connects each electrode plate 23 in an insulation way by the insulation thermal conduction glue 24. One side of the sheet metal 253 is formed a plurality of long strip shape dents 2511, but not limited thereto. Each spring late 132 of each side plate 13 is against the thermal diffusion body 25 to be away from a side surface of the PTC heating component 21. Besides, each sheet metal 253 and each fixation plate 252 is a component made of aluminum or aluminum alloy.

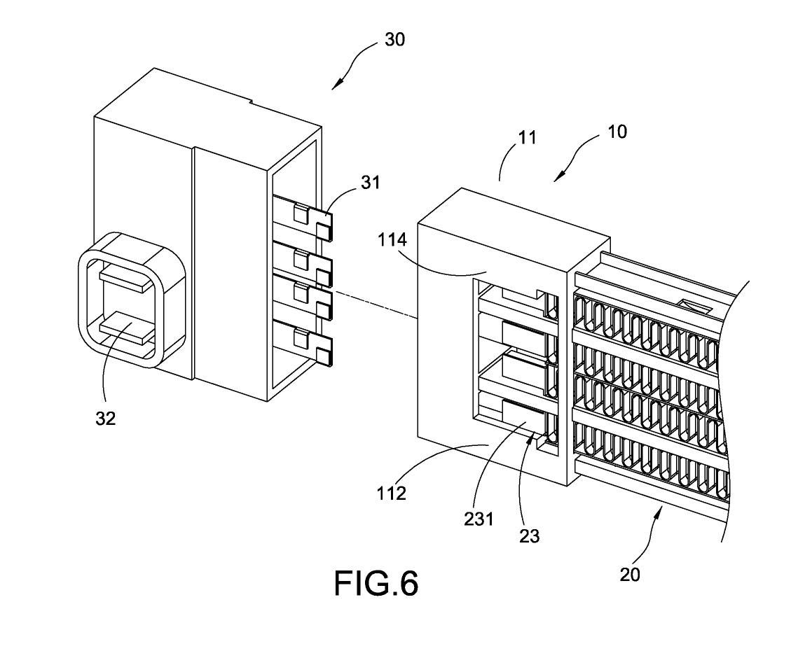

Please refer to FIG. 6, which is a three dimensional schematic view of the first preferred embodiment according to the present invention. The heater 1 further includes a connector 30 and a control circuit 40. One end of the connector 30 is provided with a plurality of terminals 31. Each terminal 31 is inserted and connected to each through hole 114 of the first base 11 respectively, and the terminals 31 are accommodated in the open trough 112 of the first base 11. Each terminal 31 is electrically connected to the conductive terminal 231 of each electrode plate 23. The control circuit 40 is provided between each terminal 31 of the connector 30 and the conductive terminal 231 of each electrode plate 23. Besides, the side of the connector 30 that is away from the first base 11 is provided with a connection port 32, which is used to electrically connect the power source or any other equipment.

When the heater 1 is ready to be assembled, each ceramic heating plate 211 is fixed inside each fixation trough 2121 of the fixation stand 212, and both sides of each electrode plate 23 and each PTC heating plate 211 are stuck with the thermal conduction glue 22. Afterward, each thermal diffusion body 25 connects each electrode plate 23 with the insulation thermal conduction glue 24. And then, the side plate 13 is placed on both sides of the heating module 20, and both ends of each side plate 13 and the heating module 20 are connected to the first base 11 and the second base 12 respectively. The connector 30 is connected to the first base 11, and each terminal 31 of the connector 30 is electrically connected to the conductive terminal 231 of each electrode plate 20 within the first base 11. At last, a control circuit is provided between each terminal 31 of the connector 30 and the conductive terminal 231 of each electrode plate 20.

After the assembling, the electricity is conducted from the terminal 31 of the connector 30 to each conductive terminal 231 of each electrode plate 23 by connecting the power cord to the connection port 32 of the connector 30. The electricity is conducted to each PTC heating plate 211 via each electrode plate 23. Since the resistance of the PTC heating plate 211 is big, the electricity can be transferred to heat, and the heat is further conducted to each thermal diffusion body 25 via the thermal conduction glue 22, each electrode plate 23, and the insulation thermal conduction glue 24. The heat finally dissipates into the air from each thermal diffusion body 25, thereby achieving the goal of heating the air.

The thermal conduction glue 22 has the features of heat and electricity conduction, which is able to improve the electricity conduction efficiency from the electrode plate 23 to each PTC heating plate 211. Thus, the efficiency of transferring electricity to heat of the PTC heating plate 211 can be improved, and the heat generated by each PTC heating plate 211 can be more efficiently conducted to each electrode plate 23 as well. Besides, the insulation thermal conduction glue 24 has the features of electricity isolation and heat conduction, and the electricity conduction from each electrode plate 23 to each thermal diffusion body 25 can be prevented, and so do the electricity leakage.

In addition, since each electrode plate 23 is connected to each PTC heating plate 211 and each thermal conduction body 25 by the thermal conduction glue 22 and the insulation thermal conduction glue 24, the assembling of the heater 1 is more easy and convenient than the conventional heater.

Besides, by the design that the terminal 31 of the connector 30 and the conductive terminal 231 of each electrode plate 23 are exposed to the open trough 112 of the first base 11, the short-circuited or the malfunctioned control circuit can be repaired directly from the open trough 112 without taking off the first base from the heater 1, thereby saving the repairing and maintaining time.

Moreover, when the road is bumping in driving, the vibration resulted from the bumping can be minimized by the spring plate 2122 of the fixation 212 and each spring plate 132 of each side plate 13, and the damage of the heating module 20 by collision with the framework 10 can be prevented.

In addition, the peak of one side of the fin 251 can be provided with a plurality of long strip shape dents 2511 to increase the contact area of each fin 251 and the air, which also enhances the heat exchange effect between each thermal diffusion body 25 and the air, but not limited thereto. By doing so, the heat of the thermal diffusion body 25 can be dissipated into the air more swiftly, and the air heating effect can be improved as well. Compared to the conventional 0.28 cm thickness of the fin, the thickness of the fin 251 can also be lower to 0.2 cm, which can significantly lower the cost of the material.

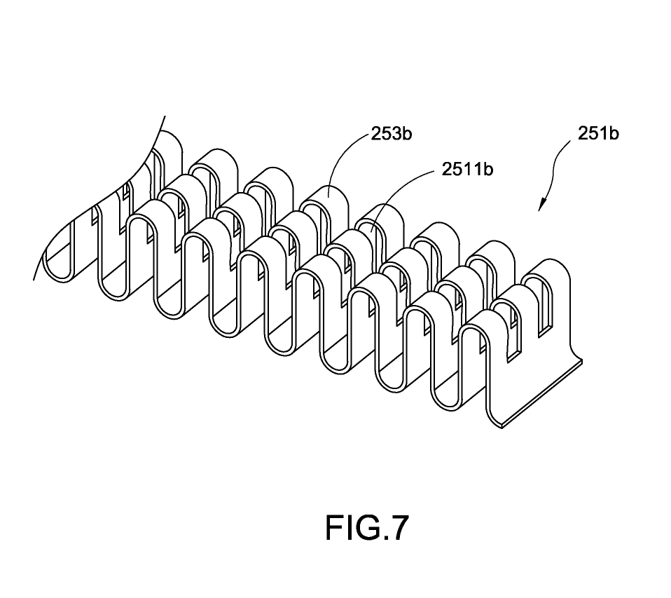

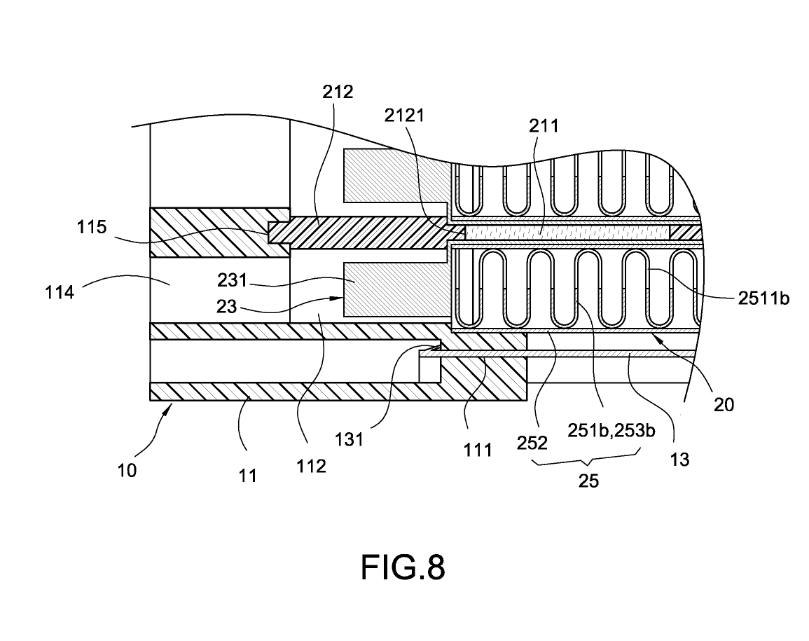

Please refer to FIGS. 7 and 8, which are the schematic view of the fins and the operation diagram of the second embodiment according to the present invention. The main difference compared to the previous embodiment is that each fin 251 of the thermal diffusion body 25 is changed to each fin 251b. Each fin 251b is formed with a wave form sheet metal 253b, and one side of each fin 251b is provided with a plurality of grooves 2511b, but not limited thereto. By this arrangement, the contact area of each fin 25 lb and the air can be increased, and the heat exchange effect of each thermal diffusion body 25 and the air can be improved as well.

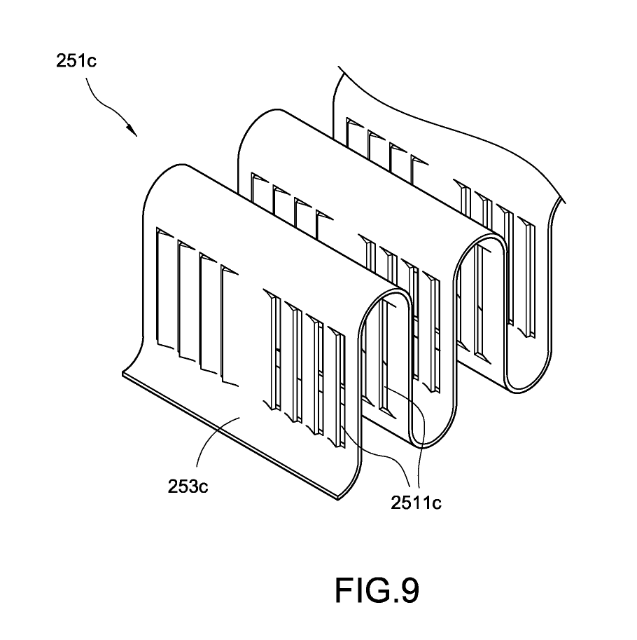

Please refer to FIG. 9, which is the schematic view of the fins of the third embodiment according to the present invention. The main difference compared to the previous embodiment is that each fin 251 is changed to each fin 251c. Each fin 251b is formed with a wave form sheet metal 253c, and each ventral side of each fin 251c is provided with a plurality of grooves 2511c, but not limited thereto. Each fixation plate 252 is connected to both sides of each fin 251c respectively. By this arrangement, the contact area of each fin 251c and the air can be increased, and the heat exchange effect of each thermal diffusion body 25 and the air can be improved as well. Besides, the thickness of the sheet plate 253c can be decreased under the same heat dissipation effect, and the cost of the material will decrease accordingly.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A heater used in car interior compartment, comprising:
a framework including a first base and a second base arranged in interval with the first base; and
a heating module provided between the first base and the second base, the heating module including:
a positive temperature coefficient (PTC) heating component;
a thermal conduction glue;
a pair of electrode plates connecting to both sides of the PTC heating component by the thermal conduction glue;
a insulation thermal conduction glue; and
a pair of thermal diffusion body, each thermal diffusion body connecting each electrode plate in an insulation way by the insulation thermal conduction glue.

2. The heater according to claim 1, wherein one end of the first base near the heating module is provided with a slot, and one side of the electrode plate near the first base is provided with a conductive terminal inserting in the slot.

3. The heater according to claim 2, wherein one side of the first base is provided with an open trough connected to the slot, and the conductive terminal is exposed to the open trough.

4. The heater according to claim 1, wherein the framework further includes a pair of side plates provided on both sides of the heating module, and both ends of the pair of the side plates are connected to the first base and the second base, respectively.

5. The heater according to claim 4, wherein the side plate is connected to the first base and the second base by welding.

6. The heater according to claim 4, wherein both ends of the side plate are provided with a tenon, and the first base is provided with a first clipping slot for being lodged by one of the tenons, and the second base is provided with a second clipping slot for being lodged by the other tenon.

7. The heater according to claim 4, wherein one side of the side plate near the heating module is provided with a plurality of sprint plates, and each sprint plate is against the thermal diffusion body.

8. The heater according to claim 7, wherein the PTC heating component includes at least one PTC heating plate and a fixation stand, and the fixation stand is provided with at least one fixation trough for fixing the PTC heating plate, and the pair of the electrode plates are connected to both sides of the fixation stand and stuck to both sides of the PTC heating plate by the thermal conduction glue.

9. The heater according to claim 8, wherein the first base is provided with a first inserting hole for inserting one end of the fixation stand, and the second base is provided with a second inserting hole for inserting the other end of the fixation stand.

10. The heater according to claim 9, wherein one end of the fixation stand near the second base is provided with sprint plates, and the sprint plates are against the bottom surface of the second inserting hole.

11. The heater according to claim 1, wherein the thermal diffusion body is provided with a plurality of fins, each fin is formed with a wave form sheet metal, and one side of each fin is provided with a plurality of long strip shape dents.

12. The heater according to claim 1, wherein the thermal diffusion body is provided with a plurality of fins, each fin is formed with a wave form sheet metal, and one side of each fin is provided with a plurality of grooves.

13. The heater according to claim 1, wherein the thermal diffusion body is provided with a plurality of fins, each fin is formed with a wave form sheet metal, and ventral side of each fin is provided with a plurality of grooves.

14. The heater according to claim 11, wherein the thermal diffusion body further includes a pair of fixation plates, and each fixation plate welds to both sides of each fin.

15. The heater according to claim 12, wherein the thermal diffusion body further includes a pair of fixation plates, and each fixation plate welds to both sides of each fin.

16. The heater according to claim 13, wherein the thermal diffusion body further includes a pair of fixation plates, and each fixation plate welds to both sides of each fin.

17. The heater according to claim 2, further comprising a connector, one end of the connector provided with a plurality of terminals, one end of the first base away from the heating module being provided with a plurality of through hole connecting to the slot, each terminal inserting into each corresponding through hole and being accommodated into the slot and electrically connected to each conductive terminal, and a control circuit being provided between each terminal and each conductive terminal.
